(19) United States
(12) Patent Application Publication
(10) Pub. No.: US 2026/0246557 A1
(43) Pub. Date: Aug. 20, 2026

(54) COVERT TRANSMISSION METHOD AGAINST ACTIVE AND PASSIVE COOPERATIVE ATTACKS IN COGNITIVE RADIO NETWORK

(71) Applicant: China Three Gorges University, Yichang (CN)

(72) Inventors: Shouzhi XU, Yichang (CN); Rui CHEN, Yichang (CN); Binbin TIAN, Yichang (CN); Mei YU, Yichang (CN); Tian WU, Yichang (CN); Jia ZHU, Yichang (CN); Huan ZHOU, Yichang (CN); Xiaojun LIU, Yichang (CN); Yang LI, Yichang (CN); Bibo XIAO, Yichang (CN); Kai MA, Yichang (CN); Liang ZHAO, Yichang (CN); Ke WANG, Yichang (CN); Liping FAN, Yichang (CN)

(21) Appl. No.: 19/642,723

(22) Filed: Apr. 9, 2026

(30) Foreign Application Priority Data
Sep. 30, 2025 (CN) 202511425221.8

(51) Int. Cl. H04K 1/02; H04L 9/40; H04W 12/102

(52) U.S. Cl. CPC H04K 1/02; H04L 63/1475; H04W 12/102

(57) ABSTRACT

This application provides a covert transmission method against active and passive cooperative attacks in a cognitive radio network. This method uses a joint design of noise uncertainty and power uncertainty to combat powerful collusion eavesdroppers. Then, the error detection probability of collusion eavesdroppers in the network and the covert transmission performance of legitimate users are analyzed. Finally, the numerical results show that the proposed scheme can guarantee the covert performance of the system, and can also resist the active and passive cooperative attacks of the collusive eavesdropper.

### TECHNICAL FIELD

In the field of wireless communication technology, the present disclosure specifically relates to a covert transmission method against active and passive cooperative attacks in a cognitive radio network.

### BACKGROUND

With the rapid advancement of wireless communication networks, spectrum resources have grown increasingly scarce, which in turn constrains the further development of wireless communications. Cognitive radio has emerged as an effective solution to address spectrum scarcity and has been deployed in various wireless communication scenarios, including the Internet of Vehicles, cellular networks, and military Internet of Things (IoT). However, due to the open and broadcast nature of wireless channels, along with potential adversarial interference, Cognitive Radio Networks (CRNs) remain vulnerable to a range of security attacks. Thus, it is imperative to address the security challenges in CRNs. A review of existing literature reveals that technologies for securing CRNs can be categorized into three main strategies. The first approach focuses on enhancing information confidentiality through upper-layer encryption algorithms. The second strategy employs Physical Layer Security (PLS) solutions to tackle security issues. Although both encryption and PLS technologies protect information content from attacks at different layers, they may still fall short as adversaries' capabilities continue to grow. Simply safeguarding content from interception and decryption is increasingly insufficient. Against this backdrop, a third method has gained attention: enhancing user privacy in CRNs by protecting communication behavior, known as covert communication.

Currently, several studies have investigated covert communication in CRNs, but existing techniques primarily address covertness against passive eavesdroppers. As wireless communication evolves, eavesdroppers' capabilities have also advanced. In real-world networks, multiple passive and active eavesdroppers may collaborate to launch attacks. Therefore, there is an urgent need for a covert transmission method in CRNs that can ensure system covertness while resisting both active and passive cooperative attacks by colluding eavesdroppers.

### SUMMARY

The purpose of the present disclosure is to solve the technical problems in the above background, and proposes a covert transmission method against active and passive cooperative attacks in a cognitive radio network, including the following steps:

S1, constructing a CRN system including an authorized network and a secondary network, the authorized network consists of an authorized transmitter and an authorized receiver, the secondary network consists of a secondary transmitter, a secondary receiver and K eavesdropping nodes, K eavesdropping nodes implement active and passive cooperative attacks on eavesdropping nodes with the best channel gain, and actively send artificial noise to interfere with a communication between the secondary transmitter and the secondary receiver, the remaining eavesdropping nodes perform passive eavesdropping and share AN random seeds to eliminate an influence of artificial noise on their own detection.

S2, after the secondary transmitter judges that a spectrum of the authorized transmitter is idle through energy detection, transmitting a hidden signal to the secondary receiver, a received signal at the secondary receiver satisfies:

$${y}^{S R} [ t ] = \sqrt{{P}^{S T}} {x}_{T} [ t ] + \sqrt{{P}_{j}} {x}_{E} [ t ] + {n}^{S R} [ t ] ;$$

where P^{ST} is the transmit power of the secondary transmitter, x_{E}[t] is an artificial noise signal, Pⱼ is the power of Eveⱼ, n^{SR}[t] is an SR Gaussian noise and n^{SR}~N(0,N^{SR});

S3, distributing the transmit power P^{ST} of the secondary transmitter evenly on

$$[ 0 , {P}_{max}^{S T} ]$$

for power uncertainty, combined with a distribution of noise at the eavesdropping node on

$$[ \frac{{N}_{e}}{ρ} , ρ {N}_{e} ] ,$$

Nₑ is a nominal noise power, and ρ is a noise uncertainty parameter; taking “a minimum error detection probability ξₘᵢₙ≥1−ε of the eavesdropping node, ε is any small positive number” as a covert constraint, numerically searching for an optimal transmission power

$${P}_{max}^{S T}$$

to maximize a covert rate of the secondary receiver:

$${R}^{S R} = ( 1 - μ ) T {log}_{2} ( 1 + {γ}^{S R} ) ( 1 - {P}_{f}^{S T} ) ;$$

where

$${γ}^{S R} = \frac{{P}^{S T} {\vert {h}^{TR} \vert}^{2}}{{P}_{j} {\vert {h}^{{E}_{j} R} \vert}^{2} + {N}^{S R}}$$

is a signal-to-noise ratio; μ is a spectrum sensing time, T is a transmission period, and

$${P}_{f}^{S T}$$

is a false alarm probability, h^{TR} and h^{E}^{ⱼ}^{R} denote channel gains from the secondary transmitter and Eveⱼ to the secondary receiver, which are expressed as

$${h}^{T R} ∼ 𝒩 ( 0 , {σ}_{{h}^{T R}}^{2} ) and {h}^{{E}_{j} R} ∼ 𝒩 ( 0 , {σ}_{{h}^{{E}_{j} R}}^{2} ) ,$$

respectively.

In some embodiments, all wireless channels adopt an independent Rayleigh fading model with quasi-static characteristics, and a channel coefficient remains unchanged in a single time slot and changes independently between different time slots; all nodes work in single-antenna half-duplex mode.

In some embodiments, the secondary transmitter judges that the spectrum of the authorized transmitter is idle through energy detection, specifically: the secondary transmitter receives a possible signal of the authorized transmitter in a spectrum sensing stage, calculates an energy value of the received signal and compares it with a preset sensing threshold. If the energy value is lower than the threshold, it is judged that the spectrum of the authorized transmitter is idle, and the covert transmission is triggered, otherwise, it is judged that the authorized transmitter occupies the spectrum, and the covert transmission is suspended.

In some embodiments, in a cooperative attack, several eavesdropping nodes evaluate a channel gain of the secondary receiver by actively sending a pilot signal, and then select a node with an optimal gain to send artificial noise to the secondary receiver. Meanwhile, other nodes conduct passive eavesdropping, thus forming an active and passive cooperative attack on the covert transmission.

In some embodiments, the minimum error detection probability ξₘᵢₙ of the eavesdropping node is calculated by hypothesis testing: the eavesdropping node distinguishes the case where ST does not transmit H₀ and ST transmits H₁, and the received signal satisfies:

$${y}^{E v e} [ t ] = \{ \begin{matrix}{n}^{Eve} [ t ] , & {H}_{0} \\ \sqrt{{P}^{ST}} {\sum }_{i = 1}^{K - 1} {h}^{{TE}_{i}} + {x}_{T} [ t ] + {n}^{Eve} [ t ] , & {H}_{1}\end{matrix}$$

where h^{TE}^{ᵢ} denotes a channel gain from the secondary transmitter to Eveᵢ, which is expressed as

$${h}^{T {E}_{i}} ∼ 𝒩 ( 0 , {σ}_{{h}^{T E} i}^{2} ) ,$$

and |h^{TE}^{ᵢ}|² obeys an exponential distribution with a mean of

$$\frac{1}{{λ}^{T {E}_{i}}} ; {n}^{Eve} [ t ]$$

denotes an additive white Gaussian noise of the eavesdropping node, denoted as n^{Eve}~ [symbol] (0,N^{Eve}), and follows a uniform distribution on an interval of

$$[ \frac{1}{ρ} {N}_{e} , ρ {N}_{e} ] ;$$

an average received power

$${T}^{E v e} = \frac{{\sum }_{t = 1}^{N} {\vert {y}^{E v e} [ t ] \vert}^{2}}{N}$$

is calculated, N is a total number of channel usage, compared with the optimal threshold τ*, τ* satisfies

$$\frac{N e}{ρ} + {P}_{max}^{S T} {\sum }_{i = 1}^{k - 1} {\vert {h}^{T {E}_{i}} \vert}^{2} \leq {τ}^{*} \leq ρ Ne ,$$

h^{TE}^{ᵢ} denotes a channel gain of the secondary transmitter to an i-th passive eavesdropping node, ξₘᵢₙ is obtained.

In some embodiments, the error detection probability ξ of the eavesdropping node is equal to a sum of a missed detection probability and a false alarm probability; when

$${P}_{max}^{S T} {\sum }_{i = 1}^{K - 1} {\vert {h}^{T {E}_{i}} \vert}^{2} + \frac{1}{ρ} {N}_{e} \leq ρ {N}_{e} , {ξ}_{min} = 1 - \frac{{P}_{max}^{ST} {\sum }_{i = 1}^{K - 1} {\vert {h}^{T {E}_{i}} \vert}^{2}}{2 ( ρ - \frac{1}{ρ} ) {N}_{e}} ;$$

when

$${P}_{max}^{S T} {\sum }_{i = 1}^{K - 1} {\vert {h}^{T {E}_{i}} \vert}^{2} + \frac{1}{ρ} {N}_{e} > ρ {N}_{e} , {ξ}_{min} = 0 .$$

In some embodiments, a specific process of numerical search for an optimal

$${P}_{max}^{S T}$$

is as follows: transversing a positive value range of

$${P}_{max}^{S T} ,$$

calculating ξₘᵢₙ for each candidate

$${P}_{max}^{S T} ,$$

and judging whether ξₘᵢₙ≥1−ε; when ξₘᵢₙ≥1−ε, substituting it into a calculation formula of R^{SR} to obtain a corresponding rate, and finally selecting

$${P}_{max}^{S T}$$

that maximizes R^{SR} as an optimal value.

In some embodiments, a performance evaluation of covert transmission also includes covert outage probability, which is defined as a probability that the covert rate R^{SR} of the secondary receiver is lower than a preset rate threshold, the covert outage probability increases with an increase of the number of eavesdropping nodes K, and decreases with an increase of the noise uncertainty parameter ρ, when K=2, the covert outage probability is slightly better than a full-duplex eavesdropper scheme.

In some embodiments, the noise uncertainty parameter ρ>1, the greater the value of ρ, the broader the range of noise experienced by the eavesdropping node, the larger an estimation error of the eavesdropping node to the noise, the higher the ξₘᵢₙ, and the stronger the covert performance of the system; when ρ≥10, ξₘᵢₙ approaches a level of a passive eavesdropper scheme, and a joint design of power and noise uncertainty can offset a cooperative attack effect of the active and passive eavesdropper nodes.

In some embodiments, a transmission power control of the secondary transmitter satisfies a dynamic adjustment law: the optimal

$${P}_{max}^{S T}$$

decreases with the increase of the number of eavesdropping nodes K, and increases with an increase of the noise uncertainty parameter ρ; when K increases from 2 to 6, the optimal

$${P}_{max}^{S T}$$

decreases, so that a decrease of R^{SR} is controlled within 20%, when ρ increases from 2 to 20, the optimal

$${P}_{max}^{S T}$$

increases, so that the R^{SR} increases by no less than 50%.

Compared with the existing technology, the beneficial effect of the present disclosure is as follows:
(1) The present disclosure proposes a covert transmission strategy against the cooperative attacks of active and passive eavesdroppers in CRN. The strategy addresses a scenario where, while an ST secretly communicates with an SR, multiple colluding eavesdroppers simultaneously send artificial noise and eavesdrop to disrupt the covert transmission. To counter this dual threat, the ST dynamically controls its transmission power.
(2) The present disclosure rigorously derives three key performance indicators for this cooperative attack scenario: AMDEP at the Eve, the covert rate achievable at the SR, and the Covert Outage Probability (COP). Furthermore, it determines the optimal maximum transmit power under covertness constraints and the corresponding maximum covert rate attainable by the system.
(3) The results demonstrate that while the cooperative attack enhances the eavesdroppers' capability, the legitimate parties can effectively resist it through a joint design leveraging noise uncertainty and power uncertainty.

### BRIEF DESCRIPTION OF THE DRAWINGS

FIG. 1 is a covert transmission system model against the cooperative attack of active and passive eavesdroppers in CRN.

FIG. 2 is an experimental diagram of Eve's AMDEP changing with noise uncertainty in the single passive eavesdropper scheme and the full-duplex eavesdropper scheme under different eavesdropper numbers.

FIG. 3 is an experimental diagram of the COP of the SR changing with the noise uncertainty in the proposed scheme and the benchmark scheme under different numbers of eavesdroppers.

FIG. 4 is the experimental diagram of the covert rate of SR with noise uncertainty in the proposed scheme and the benchmark scheme under different numbers of eavesdroppers.

### DETAILED DESCRIPTION OF THE EMBODIMENTS

### Example 1

This embodiment provides a covert transmission method against active and passive cooperative attacks in cognitive radio networks, including:

### 1. System Model:

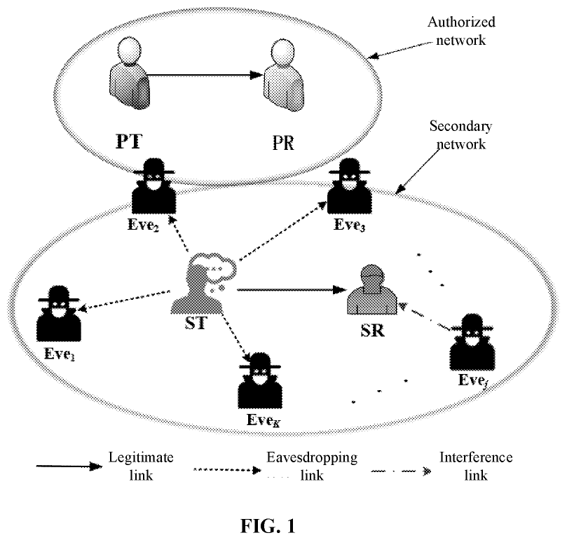

As shown in FIG. 1, in the context of CRN, the present disclosure considers a covert communication system with multiple randomly distributed hybrid active and passive eavesdropper cooperative attack scenarios. The system includes an authorized network consisting of a primary transmitter (PT) and a primary receiver (PR), and a secondary network consisting of a secondary transmitter (ST), a secondary receiver (SR), and K eavesdroppers (Eve). In our disclosure, ST secretly initiates covert information transmission to prevent multiple Eves from being known by a coordinated attack. Specifically, each Eve evaluates its channel gain with the SR by sending a pilot signal, and the Eve with the best channel gain (denoted as Eveⱼ) will actively send artificial noise (AN) to interfere with legitimate communication; meanwhile, the remaining Eve performs passive eavesdropping tasks, and they can eliminate the impact of AN on their own detection by sharing the random seeds of AN. The present disclosure assumes that all wireless channels adopt an independent Rayleigh fading model with quasi-static characteristics, which means that the channel coefficients remain unchanged in a single time slot and change independently between different time slots. In addition, all nodes work in single-antenna half-duplex mode.

We assume that ST opportunistically accesses the spectrum of PT through energy detection. Therefore, when ST detects that the spectrum of PT is idle, ST will covertly transmit its own information. Therefore, the received signal at SR can be expressed as:

$${y}^{SR} [ t ] = \sqrt{{P}^{ST}} {h}_{TR} {x}_{T} [ t ] + \sqrt{{P}_{j}} {h}_{{E}_{j} R} {x}_{E} [ t ] + {n}^{SR} [ t ] , \qquad ( 1 )$$

where P^{ST} denotes the transmission power of ST, and Pⱼ denotes the transmission power of Eveⱼ, h^{TR} and h^{E}^{ⱼ}^{R} are the channel gains from ST and Eveⱼ to SR, respectively, expressed as

$${h}^{TR} \sim 𝒩 ( 0 , {σ}_{{h}^{TR}}^{2} ) and {h}^{{E}_{j} R} \sim 𝒩 ( 0 , {σ}_{{h}^{{E}_{j} R}}^{2} ) , {\vert {h}^{TR} \vert}^{2}$$

and |h^{E}^{ⱼ}^{R}|² obey the exponential distribution with mean values of

$$\frac{1}{{λ}^{TR}} and \frac{1}{{λ}^{{E}_{j} R}} ,$$

respectively. x_{T}[t] and x_{E}[t] are the covert signal and AN signal, respectively, where t (t=1, 2, . . . , N) is the index used by each channel, and N is the total number of channel uses, satisfying E[x_{T}[t]x_{T}[t]^{†}]=1 and E[x_{E}[t]x_{E}[t]^{†}]=1. n^{SR}[t] is the additive Gaussian noise at SR, denoted as n^{SR}~ [symbol] (0, N^{SR}).

In addition, it is assumed that the transmit power of ST follows a uniform distribution on the interval

$$[ 0 , {P}_{max}^{S T} ] ,$$

and its probability density function is

$${f}_{{P}^{ST}} ( x ) = \{ \begin{matrix}\frac{1}{{P}_{max}^{ST}} , 0 < x < {P}_{max}^{S T} \\ 0 , other .\end{matrix} \qquad ( 2 )$$

The signal-to-interference-noise ratio of SR can be expressed as

$${γ}^{SR} = \frac{{P}^{ST} {\vert {h}^{T R} \vert}^{2}}{{P}_{j} {\vert {h}^{{E}_{j} R} \vert}^{2} + {N}^{SR}} . \qquad ( 3 )$$

Therefore, the achievable rate of SR can be expressed as

$${R}^{SR} = ( 1 - μ ) T {log}_{2} ( 1 + {γ}^{SR} ) ( 1 - {P}_{f}^{ST} ) , \qquad ( 4 )$$

where μ is the spectrum sensing time of ST, and

$${P}_{f}^{ST}$$

is the raise alarm probability of ST in the spectrum sensing stage.

### 2. Optimization Objectives

The goal of the present disclosure is to maximize the covert rate of SR under a given covert constraint condition. Therefore, the optimization problem is defined as follows.

$${max}_{{P}_{max}^{S T}} {R}^{SR} , \qquad ( 5 a )$$

$$s . t . \overline{{ξ}_{min}} \geq 1 - ε , \qquad ( 5 b )$$

where (5a) is a hidden constraint condition, which will be explained below.

### Covert Constraints

Based on the above situation, Eve tries to determine whether ST transmits hidden information to SR. During the transmission process, Eve will use the hypothesis test method to determine whether ST transmits hidden information according to the average energy of the received signal. In order to meet the given hidden constraints, we first calculate the minimum error detection probability of Eve, that is, the minimum probability of error judgment in the process of Eve detection. Eve needs to distinguish between two hypotheses. Considering that H₀ means that ST does not transmit covert information, H₁ means that ST transmits covert information. Considering that Eves cooperate with each other, the signals received by each Eve are aggregated at a given Eve. Therefore, the signal received by Eve can be expressed as

$${y}^{E v e} [ t ] = \{ \begin{matrix}{n}^{E v e} [ t ] , {H}_{0} \\ \sqrt{{P}^{ST}} {Σ}_{i = 1}^{K - 1} {h}^{{TE}_{i}} {x}_{T} [ t ] + {n}^{E v e} [ t ] , {H}_{1}\end{matrix} \qquad ( 6 )$$

where h^{TE}^{ᵢ} denotes the channel gain from ST to Eveᵢ, which is expressed as

$${h}^{T {E}_{i}} ∼ 𝒩 ( 0 , {σ}_{{h}^{T E} i}^{2} ) ,$$

and |h^{TE}^{ᵢ}|² obeys an exponential distribution with a mean of

$$\frac{1}{{λ}^{{TE}_{i}}} .$$

n^{Eve}[t] denotes the additive white Gaussian noise of Eve, denoted as n^{Eve}~ [symbol] (0,N^{Eve}), and follows the uniform distribution on the interval of

$$[ \frac{1}{ρ} {N}_{e} , ρ {N}_{e} ] .$$

Then, the probability density function can be given by

$${f}_{{N}^{Eve}} ( x ) = \{ \begin{matrix}\frac{1}{ρ {N}_{e} - \frac{1}{ρ} {N}_{e}} , \frac{1}{ρ} {N}_{e} < x < ρ {N}_{e} \\ 0 , other ,\end{matrix} \qquad ( 7 )$$

where Nₑ is the nominal noise power, and p is the parameter that measures the degree of noise uncertainty.

According to the Newman-Pearson criterion, Eve minimizes the probability of error detection by the likelihood ratio test. For a given transmission time slot, the average received power received by Eve is judged as follows.

$${T}^{Eve} {≷}_{{D}_{0}}^{{D}_{1}} τ , \qquad ( 8 )$$

where

$${T}^{E v e} = \frac{{\sum }_{t = 1}^{N} {\vert {y}^{E v e} [ t ] \vert}^{2}}{N}$$

denotes the average power received by Eve in a given transmission period, τ denotes the detection threshold of Eve, D₁ and D₀ respectively represent whether Eve judges whether covert communication occurs between ST and SR. When the length of the observed sample is infinite, T^{Eve} can be expressed as

$${T}^{E v e} = \{ \begin{matrix}{N}^{Eve} , & {H}_{0} \\ {P}^{ST} {\sum }_{i = 1}^{K - 1} {\vert {h}^{{TE}_{i}} \vert}^{2} + {N}^{Eve} , & {H}_{1}\end{matrix} \qquad ( 9 )$$

In the process of energy detection, the error detection probability of Eve consists of two parts, the first part is the false alarm probability, which is defined as P_{FA}≙Pr(D₁|H₀). The second part is the missed detection probability, which is defined as P_{MD}≙Pr(D₀|H₁). Then the error detection probability of Eve is expressed as

$$ξ = {P}_{MD} + {P}_{FA} . \qquad ( 10 )$$

$$when {P}_{max}^{S T} {\sum }_{i = 1}^{K - 1} {\vert {h}^{T {E}_{i}} \vert}^{2} + \frac{1}{ρ} {N}_{e} \leq ρ {N}_{e} ,$$

$$ξ = \{ \begin{matrix}1 , τ < \frac{1}{ρ} {N}_{e} \\ {p}_{1} + \frac{ρ {N}_{e} - τ}{( ρ - \frac{1}{ρ} ) {N}_{e}} , \frac{1}{ρ} {N}_{e} \leq τ < \frac{1}{ρ} {N}_{e} + {P}_{max}^{ST} {\sum }_{i = 1}^{K - 1} {\vert {h}^{{TE}_{i}} \vert}^{2} \\ 1 - \frac{{P}_{max}^{S T} {\sum }_{i = 1}^{K - 1} {\vert {h}^{T {E}_{i}} \vert}^{2}}{2 ( ρ - \frac{1}{ρ} ) {N}_{e}} , \frac{1}{ρ} {N}_{e} + {P}_{max}^{ST} {\sum }_{i = 1}^{K - 1} {\vert {h}^{{TE}_{i}} \vert}^{2} \leq τ < ρ {N}_{e} \\ {p}_{3} , ρ {N}_{e} \leq τ < ρ {N}_{e} + {P}_{max}^{S T} {\sum }_{i = 1}^{K - 1} {\vert {h}^{T {E}_{i}} \vert}^{2} \\ 1 , τ \geq ρ {N}_{e} + {P}_{max}^{S T} {\sum }_{i = 1}^{K - 1} {\vert {h}^{T {E}_{i}} \vert}^{2}\end{matrix} \qquad ( 11 )$$

$$where {p}_{1} = \frac{\frac{1}{2} {τ}^{2} - \frac{{N}_{e}}{ρ} τ + \frac{{( \frac{N e}{ρ} )}^{2}}{2}}{{P}_{max}^{S T} {\sum }_{i = 1}^{K - 1} {\vert {h}^{T {E}_{i}} \vert}^{2} ( ρ - \frac{1}{ρ} ) {N}_{e}} ,$$

$${p}_{3} = 1 - [ \frac{ρ {N}_{e} - τ + {P}_{max}^{S T} {\sum }_{i = 1}^{K - 1} {\vert {h}^{T {E}_{i}} \vert}^{2}}{( ρ - 1 / ρ ) Ne} + \frac{\begin{matrix}τ ( τ - {P}_{max}^{S T} {\sum }_{i = 1}^{K - 1} {\vert {h}^{T {E}_{i}} \vert}^{2} ) - \frac{1}{2} ( τ - \\ {{P}_{max}^{S T} {\sum }_{i = 1}^{K - 1} {\vert {h}^{T {E}_{i}} \vert}^{2} )}^{2} - ρ {N}_{e} τ - \frac{{( ρ {N}_{e} )}^{2}}{2}\end{matrix}}{{P}_{max}^{S T} {\sum }_{i = 1}^{K - 1} {\vert {h}^{T {E}_{i}} \vert}^{2} ( ρ - \frac{1}{ρ} ) {N}_{e}} ] .$$

$$When {P}_{max}^{S T} {\sum }_{i = 1}^{K - 1} {\vert {h}^{T {E}_{i}} \vert}^{2} + \frac{1}{ρ} {N}_{e} > ρ {N}_{e} ,$$

$$ξ = \{ \begin{matrix}1 , τ < \frac{1}{ρ} {N}_{e} \\ {p}_{1} + \frac{ρ {N}_{e} - τ}{( ρ - \frac{1}{ρ} ) {N}_{e}} , \frac{1}{ρ} {N}_{e} \leq τ < \frac{1}{ρ} {N}_{e} + {P}_{max}^{S T} {\sum }_{i = 1}^{K - 1} {\vert {h}^{T {E}_{i}} \vert}^{2} \\ 0 , \frac{1}{ρ} {N}_{e} + {P}_{max}^{S T} {\sum }_{i = 1}^{K - 1} {\vert {h}^{T {E}_{i}} \vert}^{2} \leq τ < ρ {N}_{e} \\ {p}_{3} , ρ {N}_{e} \leq τ < ρ {N}_{e} + {P}_{max}^{S T} {\sum }_{i = 1}^{K - 1} {\vert {h}^{T {E}_{i}} \vert}^{2} \\ 1. τ \geq ρ {N}_{e} + {P}_{max}^{S T} {\sum }_{i = 1}^{K - 1} {\vert {h}^{T {E}_{i}} \vert}^{2}\end{matrix} \qquad ( 12 )$$

By performing derivative operations on each of the above cases, the optimal detection threshold and the minimum error detection probability of Eve are expressed as

$$\frac{{N}_{e}}{ρ} + {P}_{max}^{S T} {\sum }_{i = 1}^{K - 1} {\vert {h}^{T {E}_{i}} \vert}^{2} \leq {τ}^{*} \leq ρ {N}_{e} , \qquad ( 13 )$$

$${ξ}_{min} = \{ \begin{matrix}1 - \frac{{P}_{max}^{ST} {\sum }_{i = 1}^{K - 1} {\vert {h}^{T {E}_{i}} \vert}^{2}}{2 ( ρ - \frac{1}{ρ} ) {N}_{e}} , {P}_{max}^{ST} {\sum }_{i = 1}^{K - 1} {\vert {h}^{T {E}_{i}} \vert}^{2} + \frac{1}{ρ} {N}_{e} \leq ρ {N}_{e} \\ 0. {P}_{max}^{ST} {\sum }_{i = 1}^{K - 1} {\vert {h}^{T {E}_{i}} \vert}^{2} + \frac{1}{ρ} {N}_{e} \leq ρ {N}_{e}\end{matrix} \qquad ( 14 )$$

It is assumed that Eve does not know the instantaneous channel state information (CSI) of the eavesdropping link due to passive eavesdropping, and only grasps the statistical CSI of the channel. Therefore, we use the Average Minimum Detection Error Probability (AMDEP) to evaluate the covert performance, which is given by the following formula.

$$\overline{{ζ}_{m ι n}} = Pr [ {P}_{max}^{S T} {\sum }_{i = 1}^{K - 1} {\vert {h}^{T {E}_{i}} \vert}^{2} + \frac{1}{ρ} {N}_{e} \leq ρ {N}_{e} ] \times E [ {ξ}_{min} \vert {P}_{max}^{S T} {\sum }_{i = 1}^{K - 1} {\vert {h}^{T {E}_{i}} \vert}^{2} + \frac{1}{ρ} {N}_{e} \leq ρ {N}_{e} ] + P r [ {P}_{max}^{S T} {\sum }_{i = 1}^{K - 1} {\vert {h}^{T {E}_{i}} \vert}^{2} + \frac{1}{ρ} {N}_{e} > ρ {N}_{e} ] \times E [ {ξ}_{min} \vert {P}_{max}^{S T} {\sum }_{i = 1}^{K - 1} {\vert {h}^{T {E}_{i}} \vert}^{2} + \frac{1}{ρ} {N}_{e} > ρ {N}_{e} ] = [ \frac{Γ ( K - 1 ) - γ ( K - 1 , \frac{{λ}^{{TE}_{i}} ( ρ - \frac{1}{ρ} ) {N}_{e}}{{P}_{max}^{S T}} )}{( K - 2 ) !} ] \times [ \frac{\begin{matrix}{λ}^{{TE}_{i}} ( ρ - \frac{1}{ρ} ) {N}_{e} [ Γ ( K - 1 ) - γ ( K - 1 , \frac{{λ}^{{TE}_{i}} ( ρ - \frac{1}{ρ} ) {N}_{e}}{{P}_{max}^{S T}} ) ] - \\ \frac{{P}_{max}^{S T}}{2} [ Γ ( K ) - γ ( K , \frac{{λ}^{{TE}_{i}} ( ρ - \frac{1}{ρ} ) {N}_{e}}{{P}_{max}^{S T}} ) ]\end{matrix}}{{λ}^{T {E}_{i}} ( K - 2 ) ! ( ρ - \frac{1}{ρ} ) {N}_{e}} ] , \qquad ( 15 )$$

where Γ(a) is a complete Gamma function, γ(a, x) is an incomplete Gamma function.

Therefore, in order to achieve covert transmission, the following covert constraint should be guaranteed.

$$\overline{{ξ}_{m ι n}} \geq 1 - ε , \qquad ( 16 )$$

where ε is an arbitrarily small positive number, which is used to evaluate the strength of covert constraints.

### 3. Problem Solving

The present disclosure mainly considers the covert rate of the legal party under the condition of satisfying the covert constraint condition. Due to the complexity of the problem, the present disclosure obtains the optimal ST maximum transmission power through numerical search, thereby maximizing the covert transmission rate at SR.

### Example 2

The following shows the specific implementation of the scheme in Example 1 combined with the attached figures:

FIG. 1 shows an example of a covert transmission system against cooperative attacks by active and passive eavesdroppers in CRN. The distribution function parameter of each link is set to 1, the noise parameters of both Eve and SR are set to 1, and the covert constraint is set to 0.1.

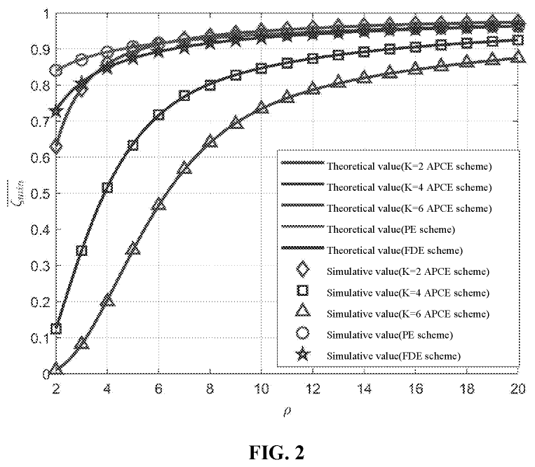

FIG. 2 shows the relationship between AMDEP and noise uncertainty of Eve when the number of Eve changes from 2 to 6, which includes five schemes: the APE scheme (K=2, 4, 6) and the benchmark scheme (PE, FDE). It can be seen that the AMDEP of the present disclosure is significantly lower than the benchmark scheme when the noise uncertainty is small or the number of Eve is large. Meanwhile, when the noise uncertainty is large enough, the AMDEP of the present disclosure can still maintain a high level and approach the benchmark scheme, which indicates that the combined effect of transmission power uncertainty and noise uncertainty can effectively resist the security risk from a multi-eavesdropper cooperative attack, and can remain covert even in the face of strong eavesdropping ability.

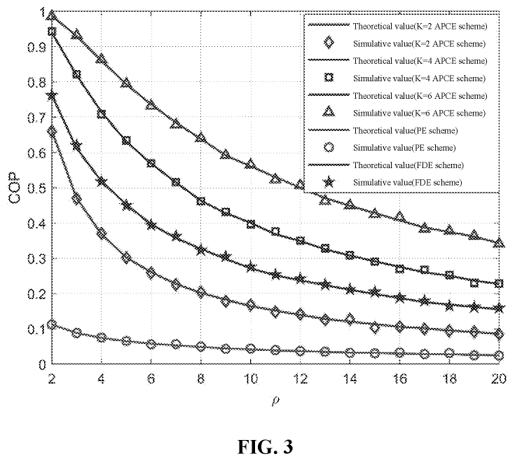

FIG. 3 shows the relationship between COP and noise uncertainty of SR when the number of Eve changes from 2 to 6, which includes five schemes: the APE scheme (K=2, 4, 6) and the benchmark scheme (PE, FDE). It can be seen that increasing the number of Eve will increase the COP of SR, and with the increase of noise uncertainty, the COP of SR shows a downward trend. Because a cooperative attack will reduce Eve's DEP and force ST to reduce its covert transmission power, on the contrary, higher noise uncertainty will increase Eve's DEP and enable ST to amplify its covert transmission power. Compared with the PE and FDE scheme benchmarks, the APE scheme of the present disclosure performs slightly worse than the PE scheme, but slightly better than the FDE at K=2. These results show that the combination of transmission power uncertainty and noise uncertainty effectively counteracts the cooperative attack of multiple collusive eavesdroppers. Despite the increased threat of eavesdropping, the present disclosure still maintains the reliability of covert communication.

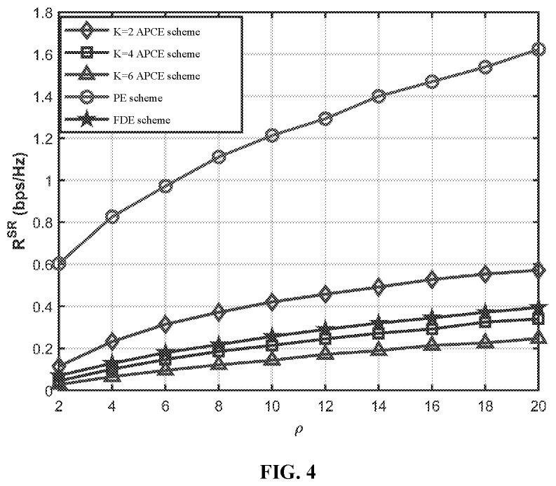

FIG. 4 shows the relationship between the covert rate of SR and noise uncertainty when the number of Eve changes from 2 to 6. It contains five schemes: the APE scheme of the present disclosure (K=2, 4, 6) and the benchmark scheme (PE, FDE). It can be seen that the covert rate of SR decreases with the increase of the number of eavesdroppers, but increases with the increase of noise uncertainty. This is because the cooperative attack of multiple collusive eavesdroppers enhances the detection performance of Eve, thereby reducing its DEP, which in turn forces ST to reduce its covert transmission power, resulting in a decrease in covert rate. However, as the noise uncertainty increases, the DEP of Eve also increases, increasing covert transmission power and covert rate. Compared with the PE and FDE scheme benchmarks, although the performance of the APE scheme of the present disclosure is not completely superior to the benchmark scheme, the results show that even if the detection ability of Eve is enhanced, the covert rate can still maintain a positive growth. The research results emphasize that through uncertainty design, the present disclosure can protect the covert transmission of legitimate users.

The above embodiments are used only to illustrate the technical scheme of the present disclosure and not to restrict it; although the present disclosure is described in detail with reference to the aforementioned embodiments, ordinary technicians in this field should understand that they can still modify the technical solutions recorded in the aforementioned embodiments, or replace some of the technical features equivalently; these modifications or replacements do not make the essence of the corresponding technical scheme separate from the spirit and scope of the technical scheme of each embodiment of the present disclosure.

What is claimed is:

1. A covert transmission method against active and passive cooperative attacks in a cognitive radio network, comprising the following steps:
S1, constructing a CRN system comprising an authorized network and a secondary network, wherein the authorized network consists of an authorized transmitter and an authorized receiver, the secondary network consists of a secondary transmitter, a secondary receiver and K eavesdropping nodes, K eavesdropping nodes implement active and passive cooperative attacks on eavesdropping nodes with a best channel gain, and actively send artificial noise to interfere with a communication between the secondary transmitter and the secondary receiver, the remaining eavesdropping nodes perform passive eavesdropping and share AN random seeds to eliminate an influence of artificial noise on their own detection;
S2, after the secondary transmitter judges that a spectrum of the authorized transmitter is idle through energy detection, transmitting a hidden signal to the secondary receiver, wherein a received signal at the secondary receiver satisfies:
$${y}^{S R} [ t ] = \sqrt{{P}^{S T}} {x}_{T} [ t ] + \sqrt{{P}_{j}} {x}_{E} [ t ] + {n}^{S R} [ t ] ;$$
where P^{ST} is a transmit power of the secondary transmitter, x_{E}[t] is an artificial noise signal, Pⱼ is a power of Eveⱼ, n^{SR}[t] is an SR Gaussian noise and n^{SR}~N(0,N^{SR});
S3, distributing the transmit power P^{ST} of the secondary transmitter evenly on
$$[ 0 , {P}_{max}^{S T} ]$$
for power uncertainty, combined with a distribution of noise at the eavesdropping node on
$$[ \frac{{N}_{e}}{ρ} , ρ {N}_{e} ] ,$$
Nₑ is a nominal noise power, and ρ is a noise uncertainty parameter; taking “a minimum error detection probability ξₘᵢₙ≥1−ε of the eavesdropping node, ε is any small positive number” as a covert constraint, numerically searching for an optimal transmission power
$${P}_{max}^{S T}$$
to maximize a covert rate of the secondary receiver:
$${R}^{S R} = ( 1 - μ ) T {log}_{2} ( 1 + {γ}^{S R} ) ( 1 - {P}_{f}^{S T} ) ;$$
where
$${γ}^{S R} = \frac{{P}^{S T} {\vert {h}^{T R} \vert}^{2}}{{P}_{j} {\vert {h}^{{E}_{j} R} \vert}^{2} + {N}^{S R}}$$
is a signal-to-noise ratio; μ is a spectrum sensing time, T is a transmission period, and
$${P}_{f}^{S T}$$
is a false alarm probability, h^{TR} and h^{E}^{ⱼ}^{R} denote channel gains from the secondary transmitter and Eveⱼ to the secondary receiver, which are expressed as
$${h}^{T R} ∼ 𝒩 ( 0 , {σ}_{{h}^{T R}}^{2} ) and {h}^{{E}_{j} R} ∼ 𝒩 ( 0 , {σ}_{{h}^{{E}_{j} R}}^{2} ) ,$$
respectively.

2. The covert transmission method against active and passive cooperative attacks in the cognitive radio network according to claim 1, wherein all wireless channels adopt an independent Rayleigh fading model with quasi-static characteristics, and a channel coefficient remains unchanged in a single time slot and changes independently between different time slots; and wherein all nodes work in a single-antenna half-duplex mode.

3. The covert transmission method against active and passive cooperative attacks in the cognitive radio network according to claim 1, wherein the secondary transmitter judges that the spectrum of the authorized transmitter is idle through energy detection, specifically: the secondary transmitter receives a possible signal of the authorized transmitter in a spectrum sensing stage, calculates an energy value of the received signal and compares it with a preset sensing threshold; if the energy value is lower than the threshold, it is judged that the spectrum of the authorized transmitter is idle, and the covert transmission is triggered, otherwise, it is judged that the authorized transmitter occupies the spectrum, and the covert transmission is suspended.

4. The covert transmission method against active and passive cooperative attacks in the cognitive radio network according to claim 1, wherein in a cooperative attack, several eavesdropping nodes evaluate a channel gain of the secondary receiver by actively sending a pilot signal, and then select a node with an optimal gain to send an artificial noise to the secondary receiver, meanwhile, other nodes conduct passive eavesdropping, thus forming an active and passive cooperative attack on the covert transmission.

5. The covert transmission method against active and passive cooperative attacks in the cognitive radio network according to claim 1, wherein the minimum error detection probability ξₘᵢₙ of the eavesdropping node is calculated by hypothesis testing: the eavesdropping node distinguishes the case where ST does not transmit H₀ and ST transmits H₁, and the received signal satisfies:
$${y}^{Eve} [ t ] = \{ \begin{matrix}{n}^{Eve} [ t ] , & {H}_{0} \\ \sqrt{{P}^{ST}} {\sum }_{i = 1}^{K - 1} {h}^{{TE}_{i}} {x}_{T} [ t ] + {n}^{Eve} [ t ] , & {H}_{1}\end{matrix}$$
where h^{TE}^{ᵢ} denotes a channel gain from the secondary transmitter to Eveᵢ, which is expressed as
$${h}^{{TE}_{i}} ∼ 𝒩 ( 0 , {σ}_{{h}^{TE} i}^{2} ) ,$$
and |h^{TE}^{ᵢ}|² obeys an exponential distribution with a mean of
$$\frac{1}{{λ}^{{TE}_{i}}} ;$$
n^{Eve}[t] denotes an additive white Gaussian noise of the eavesdropping node, denoted as n^{Eve}~ [symbol] (0,N^{Eve}), and follows a uniform distribution on an interval of
$$[ \frac{1}{ρ} {N}_{e} , ρ {N}_{e} ] ;$$
an average received power
$${T}^{Eve} = \frac{{\sum }_{t = 1}^{N} {\vert {y}^{Eve} [ t ] \vert}^{2}}{N}$$
is calculated, N is a total number of channel usage, compared with the optimal threshold τ*, τ* satisfies
$$\frac{Ne}{ρ} + {P}_{max}^{ST} {\sum }_{i = 1}^{k - 1} {\vert {h}^{{TE}_{i}} \vert}^{2} \leq {τ}^{⋆} \leq ρ Ne ,$$
h^{TE}^{ᵢ} denotes a channel gain of the secondary transmitter to an i-th passive eavesdropping node, and ξₘᵢₙ is obtained.

6. The covert transmission method against active and passive cooperative attacks in the cognitive radio network according to claim 5, wherein an error detection probability ξ of the eavesdropping node is equal to a sum of a missed detection probability and a false alarm probability; wherein,
when
$${P}_{max}^{ST} {\sum }_{i = 1}^{K - 1} {\vert {h}^{{TE}_{i}} \vert}^{2} + \frac{1}{ρ} {N}_{e} \leq ρ {N}_{e} , {ξ}_{min} = 1 - \frac{{P}_{max}^{ST} {\sum }_{i = 1}^{K - 1} {\vert {h}^{{TE}_{i}} \vert}^{2}}{2 ( ρ - \frac{1}{ρ} ) {N}_{e}} ;$$
and
when
$${P}_{max}^{ST} {\sum }_{i = 1}^{K - 1} {\vert {h}^{{TE}_{i}} \vert}^{2} + \frac{1}{ρ} {N}_{e} > ρ {N}_{e} , {ξ}_{min} = 0 .$$

7. The covert transmission method against active and passive cooperative attacks in the cognitive radio network according to claim 6, wherein a specific process of numerical search for an optimal
$${P}_{max}^{ST}$$
is as follows: transversing a positive value range of
$${P}_{max}^{ST} ,$$
calculating ξₘᵢₙ for each candidate
$${P}_{max}^{ST} ,$$
and judging whether ξₘᵢₙ≥1−ε; when ξₘᵢₙ≥1−ε, substituting ξₘᵢₙ into a calculation formula of R^{SR} to obtain a corresponding rate, and finally selecting a
$${P}_{max}^{ST}$$
that maximizes R^{SR} as an optimal value.

8. The covert transmission method against active and passive cooperative attacks in the cognitive radio network according to claim 1, wherein a performance evaluation of covert transmission also comprises a covert outage probability, which is defined as a probability that a covert rate R^{SR} of the secondary receiver is lower than a preset rate threshold, wherein the covert outage probability increases with an increase of a number of eavesdropping nodes K, and decreases with an increase of the noise uncertainty parameter ρ, when K=2, the covert outage probability is slightly better than a full-duplex eavesdropper scheme.

9. The covert transmission method against active and passive cooperative attacks in the cognitive radio network according to claim 1, wherein the noise uncertainty parameter ρ>1, and wherein the greater the value of ρ, the broader the range of noise experienced by the eavesdropping node, the larger an estimation error of the eavesdropping node to the noise, the higher the ξₘᵢₙ, and the stronger the covert performance of the system; and further wherein, when ρ≥10, ξₘᵢₙ approaches a level of a passive eavesdropper scheme, and a joint design of power and noise uncertainty can offset a cooperative attack effect of the active and passive eavesdropper nodes.

10. The covert transmission method against active and passive cooperative attacks in the cognitive radio network according to claim 1, wherein a transmission power control of the secondary transmitter satisfies a dynamic adjustment law: the optimal
$${P}_{max}^{ST}$$
decreases with the increase of the number of eavesdropping nodes K, and increases with an increase of the noise uncertainty parameter ρ; when K increases from 2 to 6, the optimal
$${P}_{max}^{ST}$$
decreases, so that a decrease of R^{SR} is controlled within 20%, when ρ increases from 2 to 20, and the optimal
$${P}_{max}^{ST}$$
increases, so that the R^{SR} increases by no less than 50%.
